(19) United States
(12) Patent Application Publication
(10) Pub. No.: US 2005/0029266 A1
(43) Pub. Date: Feb. 10, 2005

(54) Hinged dispensing closure with child-resistant interlock

(76) Inventors: David Ziegenhorn, Grayslake, IL (US); Robert A. Simpson, Grayslake, IL (US)

Correspondence Address: KNOBLE YOSHIDA & DUNLEAVY, LLC;Suite 1350, Eight Penn Center, 1628 John F. Kennedy Blvd., Philadelphia, PA, 19103, US

(21) Appl. No.: 10/918,536

(22) Filed: Aug. 12, 2004

Related U.S. Application Data
(63) Continuation-in-part of application No. 10/452,452, filed on Jun. 2, 2003.

(51) Int. Cl. B67D 5/33

(52) U.S. Cl. 220/256.1; 222/546; 222/556

(57) ABSTRACT

A closure for a container includes a main body portion that is constructed and arranged to be secured to a container and that has dispensing orifice defined therein for dispensing a liquid. The closure further includes a first lid portion that is hingedly mounted to the main body portion and is movable between a first, open position wherein material may be dispensed from the container through the dispensing orifice and a second, closed position wherein the dispensing orifice is blocked. A second lid portion overlies the first lid portion and is mounted for rotation with respect to the first lid portion. The second lid portion is rotatable between an unlocked position and a locked position wherein it engages the main body portion to prevent movement of the first lid portion away from the second, closed position. Pedestal bearing structure is advantageously mounted to one of the first and second lid portions that has a bearing surface that is positioned to engage the other of the first and second lid portions for reducing rotational friction between the first lid portion and the second lid portion.

This is a continuation-in-part of U.S. patent application Ser. No. 10/452,452, filed Jun. 2, 2003, the entire disclosure of which is hereby incorporated by reference as if set forth fully herein.

### BACKGROUND OF THE INVENTION

1. Field of the Invention

This invention generally relates to a dispensing closure of the type that has a hinged reclosable lid that may be swung open to reveal a dispensing orifice for the closure. More specifically, this invention relates to a child resistant dispensing closure of the type that includes an interlock for preventing the lid from being opened unless a specific additional force is imparted to the closure.

2. Description of the Related Technology

WO 97/37900 describes a hinged dispensing closure in which the lid portion is formed of a first stationary component and a second component that is relatively rotatable with respect to the first stationary component. The second component is biased toward a resting rotational position relative to be first component wherein the second component is engaged with the main body portion of the closure so as to prevent the lid from moving relative to the closure. In order to swing the lid away from the closure, the second component must be rotationally displaced by twisting it with respect to the first component, which disengages the second component from the main body portion. The required twisting action is intended to provide a level of child resistance to the closure.

In order for the closure described in WO 97/37900 to function effectively, the second, rotatable component of the lid portion must be shaped and sized so that a consumer can grip and twist it relative to the rest of the closure. Unfortunately, it was felt that it would be relatively difficult for consumers to adequately grip the rotatable upper portion of the lid portion of the closure that is described in the reference. This situation could have been addressed by increasing the thickness of the first stationary component of the lid portion, but this would have substantially increased material costs and potentially interfered with the functionality of the closure. Another potential solution might have been to increase the size of the second rotatable component, but this would also increase material costs as well as potentially adversely affect the stability of the interface between the first and second components of the lid portion.

Additionally, it is in certain circumstances possible for a small child to defeat such closures by learning how to twist the rotatable component of the lid portion relative to the rest of the closure.

A need existed for a child resistant change dispensing closure that may conveniently be operated by a consumer, is material efficient, and is dimensionally stable. In addition, a need existed for such a closure that is more child resistant than conventional closures of this type.

### SUMMARY OF THE INVENTION

Accordingly, it is an object of the invention to provide a child resistant change dispensing closure that may conveniently be operated by a consumer, is material efficient, and is dimensionally stable. It is further an object of the invention to provide such a closure that possesses a higher degree of child resistance than conventional closures of this type.

In order to achieve the above and other objects of the invention, a closure for a container that is constructed according to a first aspect of the invention includes a main body portion that is constructed and arranged to be secured to a container, the main body portion having a dispensing orifice defined therein; a first lid portion that is hingedly mounted to the main body portion and movable between a first, open position wherein material may be dispensed from the container through the orifice and a second, closed position wherein the orifice is blocked; a second lid portion that is mounted for rotation with respect to the first lid portion, the second lid portion being rotatable between an unlocked position and a locked position wherein the second lid portion engages the main body portion to prevent movement of the first lid portion away from the second, closed position; and releasable locking structure for selectively preventing the second lid portion from being moved to the unlocked position.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is an exploded perspective view depicting a closure that is constructed according to a preferred embodiment of the invention;

FIG. 2 is a perspective view depicting the assembled closure that is shown in FIG. 1;

FIG. 3 is a top plan view showing the closure in a first operational position;

FIG. 4 is a top plan view showing the closure in a second operational position;

FIG. 5 is a side elevational view of the closure;

FIG. 6 is a front elevational view of the closure; and

FIG. 7 is a cross-sectional view taken through the closure.

### DETAILED DESCRIPTION OF THE PREFERRED EMBODIMENT(S)

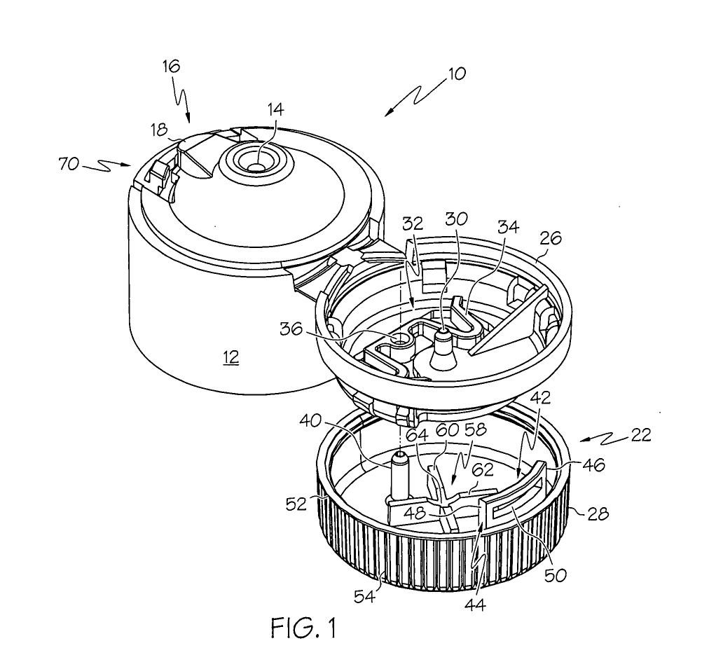

Referring now to the drawings, wherein like reference numerals designate corresponding structure throughout the views, and referring in particular to FIG. 1, a closure 10 that is constructed according to a preferred embodiment of the invention includes a main body portion 12 that is constructed and arranged to be secured to a container in conventional fashion. Main body portion 12 has a dispensing orifice 14 defined therein through which liquid material may be dispensed from a container when the closure 10 is opened.

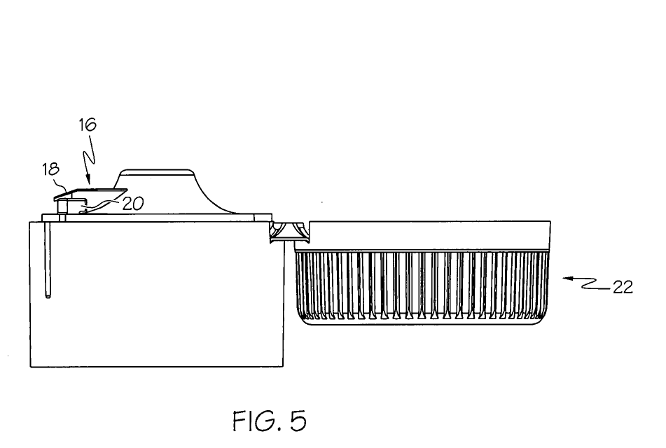

For purposes that will be described in greater detail below, main body portion 12 further includes a bead 16 defining a protruding lip portion 18 and, as may best be seen in FIG. 5, a recess 20 that is positioned immediately beneath the protruding lip portion 18. Closure 10 further includes a lid 22 that is connected to main body portion 12 by an integral hinge 24. Lid 22 includes a first stationary lid portion 26 and a second rotatable lid portion 28 that is mounted for rotation relative to the first stationary lid portion 26. A plug 30 is mounted within the first stationary lid portion 26 for sealing the dispensing orifice 14 when the closure 10 is closed, as may readily be visualized by viewing FIG. 1.

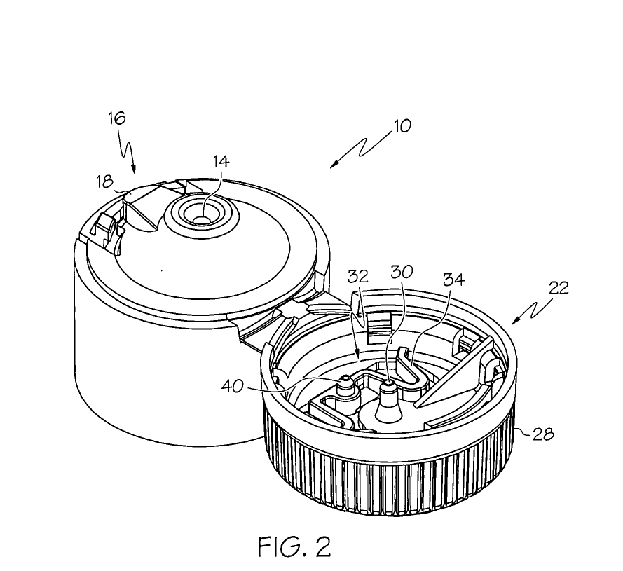

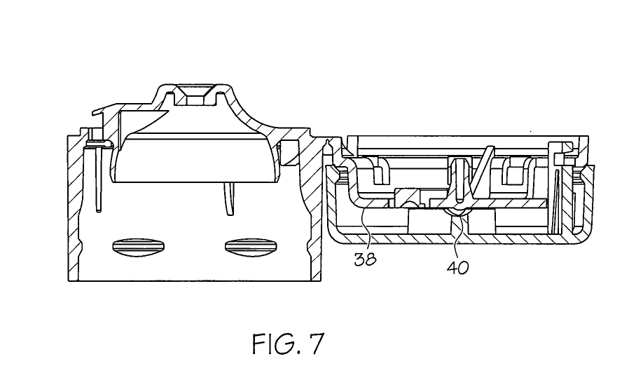

The first stationary lid portion 26 further includes biasing structure 32 for biasing the second rotatable lid portion 28 toward a locked position, as will be described in greater detail below. In the preferred embodiment, biasing structure 32 is a spring element 34 that is unitarily molded into the first stationary lid portion 26 and that has an opening 36 defined therein. Referring briefly to FIG. 2, opening 36 is sized and positioned to engage a pin 40 that is unitarily molded into the second rotatable lid portion 28. The first stationary lid portion 26 has a substantially flat and smooth bearing surface 38 facing the second rotatable lid portion 28. As is best shown in the cross-sectional view that is provided in FIG. 7, a rounded upwardly extending projection 40 is defined in the geometric center of the smooth upper bearing surface 38. Upwardly extending projection 40 is thus positioned so as to intersect with the axis of rotation of the second rotatable lid portion 28 relative to be stationary lid portion 26.

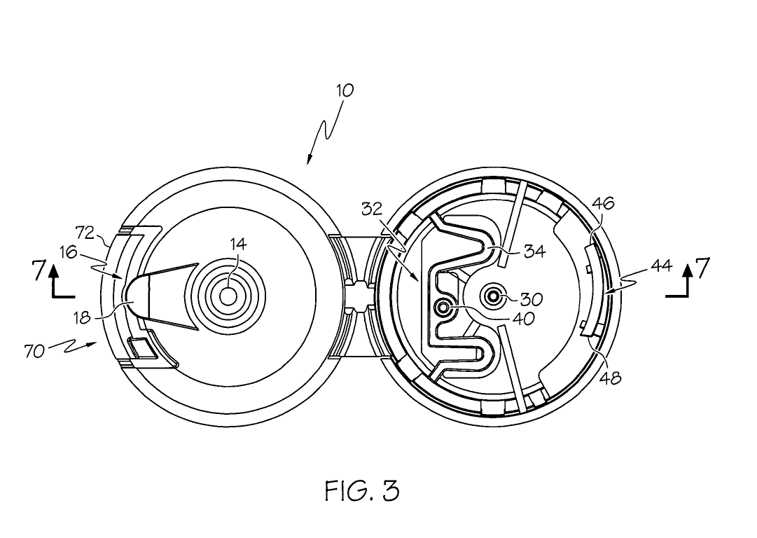

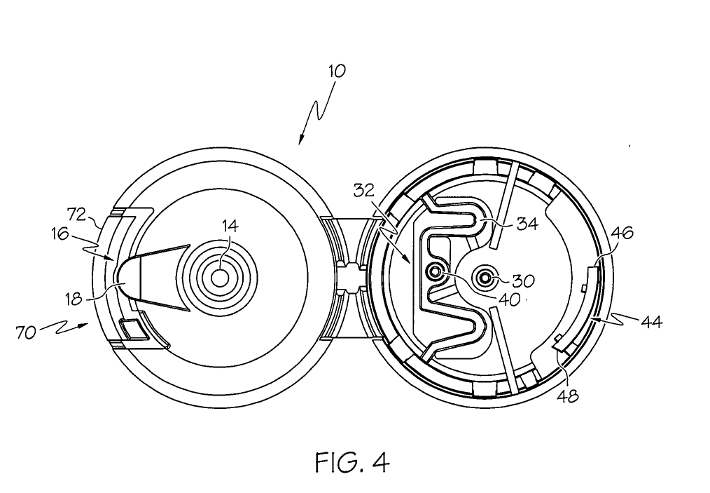

Looking again to FIG. 1, it will be seen that the second rotatable lid portion 28 includes interlock structure 42 for releasably engaging the bead structure 16 on the main body portion 12 of the closure 10. In the preferred embodiment, interlock structure 42 includes a downwardly extending projection 44 that, as is best shown in FIG. 1, has a first end 46 and a second end 48, the second end 48 being closer to the center of rotation of the second rotatable lid portion 28 than the first end 46 is. When the closure 10 is closed and the second rotatable lid portion 28 is biased toward the locked position (which is the position shown in FIG. 3, although the closure 10 is not closed), the protruding lip 18 of the bead structure 16 on the main body portion 12 of the closure 10 will be positioned within a recess 50 that is defined within the projection 44 of the second rotatable lid portion 28. This effectively prevents the lid 22 from being lifted relative to the main body portion 12, providing a measure of child resistance. However, when the second rotatable lid portion 28 is twisted by a consumer relative to the first stationery lid portion 26 (which will be in a counterclockwise direction as viewed in FIG. 4, which shows this twisted position, albeit when the closure is open), projection 44 will clear the protruding lip 18 of the bead structure 16, thereby permitting the lid 22 to be lifted away from the main body portion 12.

As may further be seen in FIG. 1, the second rotatable lid portion 28 has a downwardly extending outer apron 52 that overlies the first stationery lid portion 26 and that has a grip surface 54 defined on a circumferential outer surface thereof. The circumferential gripping surface 54 preferably has a height that is preferably at least 0.25 inches.

A radially inwardly extending bead that is unitary with apron 52 defines sidewall bearing structure that engages the first stationary lid portion 26 and stabilizes relative movement between the lid portions 26, 28. According to one particularly advantageous feature of the invention, pedestal bearing structure 58 is mounted to one of the first and second lid portions 26, 28. The pedestal bearing structure 58 has a convex bearing surface that is positioned to engage the other of the first and second lid portions 28, 26 for reducing rotational friction between the first lid portion and the second lid portion. Preferably, the pedestal bearing structure 58 pedestal bearing means is shaped as to be symmetrical about an axis of relative rotation between the first and second lid portions 26, 28 and includes a plurality, preferably at least three, radially extending arm members in order to provide dimensional stability between the lid portions 26, 28. In the preferred embodiment of the invention, pedestal bearing structure 58 is a mounted to the second rotatable lid portion 28 and includes first and second cross members 60, 62 that are molded unitarily into the inner surface of the lid portion 28 and that extend vertically elevated from the inner surface by a predetermined distance so as to permit a corresponding increase in the vertical dimension of the apron 52 without requiring a great deal of additional plastic material. This predetermined distance is preferably at least 0.062 inches, and more preferably at least 0.09 inches.

Advantageously, locating structure is provided in the pedestal bearing structure 58 for centering the second lid portion 28 with respect to the first stationary lid portion 26. In the preferred embodiment, this locating structure is formed as centering structure that is defined in the first and second cross members 60, 62, specifically a cup like recess 64 that is shaped and sized to receive the rounded projection 40 that is defined in the first stationery lid portion 26.

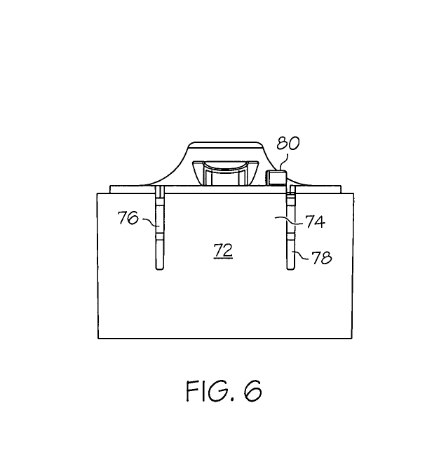

Another particularly advantageous feature of the invention involves the provision of releasable locking structure 70 for selectively preventing the second rotatable lid portion 28 from being rotated to the unlocked position relative to the first stationary lid portion 26. This provides a further measure of child resistance. In the preferred embodiment, releasable locking structure 70 is mounted to the main body portion 12 and is constructed and arranged to be unlocked by depressing an actuation surface 72 that is connected to the main body portion 12. Actuation surface 72 is located on an outer surface of a flexible movable panel portion 74 that is defined in the sidewall of the main body portion 12 by a pair of longitudinally extending slots 76, 78. Accordingly, the actuation surface 72 is unitary with the main body portion 12. Preferably, actuation surface 72 is positioned on the main body portion 12 at a location that is substantially opposite where the first lid portion 26 is hingedly mounted to the main body portion 12. The structure permits the flexible movable panel portion 74 to move radially inwardly when the actuation surface 72 is depressed, the amount of radially inward movement being greatest at the uppermost end thereof, as may be visualized by viewing FIG. 6. Releasable locking structure 70 further includes an upstanding locking member 80 that is ordinarily positioned so as to engage the projection 44 to prevent movement of the second rotatable lid portion 28 to the unlocked position. When the actuation surface 72 is depressed by a consumer, however, locking member 80 moves radially inwardly with the upper end of the flexible movable panel portion 74, moving it out of the way of the projection 44 and permitting movement of the second rotatable lid portion 28 to the unlocked position.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A closure for a container, comprising:
a main body portion that is constructed and arranged to be secured to a container, said main body portion having a dispensing orifice defined therein;
a first lid portion, said first lid portion being hingedly mounted to said main body portion and being movable between a first, open position wherein material may be dispensed from the container through said orifice and a second, closed position wherein said orifice is blocked;
a second lid portion that is mounted for rotation with respect to said first lid portion, said second lid portion being rotatable between an unlocked position and a locked position wherein said second lid portion engages said main body portion to prevent movement of said first lid portion away from said second, closed position; and
releasable locking means for selectively preventing said second lid portion from being moved to said unlocked position.

2. A closure for a container according to claim 1, wherein said releasable locking means is mounted to said main body portion.

3. A closure for a container according to claim 2, wherein said releasable locking means is constructed and arranged to be unlocked by depressing an actuation surface that is connected to said main body portion.

4. A closure for a container according to claim 3, wherein said actuation surface is unitary with said main body portion.

5. A closure for a container according to claim 4, wherein said actuation surface is positioned on said main body portion at a location that is substantially opposite where said first lid portion is hingedly mounted to said main body portion.

6. A closure for a container according to claim 1, wherein said releasable locking means is constructed and arranged to be unlocked by depressing an actuation surface that is positioned at a location that is substantially opposite where said first lid portion is hingedly mounted to said main body portion.

7. A closure for a container according to claim 6, wherein said releasable locking means is constructed and arranged to be unlocked by exerting a radially inward force on said actuation surface.

8. A closure for a container according to claim 1, wherein said releasable locking means comprises a locking member that extends upwardly from said main body portion in a first locking position wherein said locking member engages said second lid portion, and actuation means for moving said locking member to a second, unlocked position wherein said locking member permits relative movement of said second lid portion with respect to said first lid portion.

9. A closure for a container according to claim 8, wherein said second lid portion overlies said first lid portion.

10. A closure for a container according to claim 1, wherein said second lid portion includes a downwardly depending apron extending over said first lid portion

11. A closure for a container according to claim 10, wherein said second lid portion further includes a gripping surface that is constructed and arranged to be gripped by a consumer to rotate the second lid portion with respect to the first lid portion.

12. A closure for a container according to claim 1, wherein said second lid portion includes a downwardly depending projection, and wherein said releasable locking means comprises means for selectively engaging said downwardly depending projection.

13. A closure for a container according to claim 12, wherein said downwardly depending projection has a recess defined therein and wherein said main body portion comprises a protruding lid portion that is constructed and arranged to be received in said recess when said second lid portion is in said locked position

14. A closure for a container according to claim 1, further comprising biasing means for biasing said second lid portion toward said locked position.

15. A closure for a container according to claim 14, wherein said biasing means comprises a resilient spring element that is integral with said first lid portion.
